(19) United States
(12) Patent Application Publication
(10) Pub. No.: US 2014/0139561 A1
(43) Pub. Date: May 22, 2014

(54) Display Processing Method Display Processing Device and Display

(71) Applicants: HEFEI BOE OPTOELECTRONICS TECHNOLOGY CO., LTD, Anhui (CN); BOE TECHNOLOGY GROUP CO., LTD., Beijing (CN)

(72) Inventor: Yun Bok LEE, Beijing (CN)

(73) Assignees: HEFEI BOE OPTOELECTRONICS TECHNOLOGY CO., LTD, Anhui (CN); BOE TECHNOLOGY GROUP CO., LTD., Beijing (CN)

(21) Appl. No.: 14/082,355

(22) Filed: Nov. 18, 2013

(30) Foreign Application Priority Data
Nov. 22, 2012 (CN) 201210479498.5

(51) Int. Cl. G09G 5/10

(52) U.S. Cl. CPC G09G 5/10
USPC 345/690

(57) ABSTRACT

The present invention discloses a display processing method, a display processing device and a display device. The display processing method is used for the display device having display areas. The display processing method includes: obtaining a first area of the display device which is currently displaying 3D display data; controlling the display in the first area based on a first GAMMA curve, and controlling the display in a second area other than the first area in the display area based on a second GAMMA curve; the first GAMMA curve is different from the second GAMMA curve. In the embodiments of the present invention, GAMMA curves corresponding to different types of display areas are used to control the display of pixels in the different types of display areas respectively. Therefore, the display effect is improved.

### CROSS REFERENCE OF RELATED APPLICATIONS

The present application is based on and claims the benefit of priority of Chinese Patent Application No. 201210479498.5 filed on Nov. 22, 2012, the entire contents of which are hereby incorporated by reference.

### BACKGROUND OF THE INVENTION

1. Field of the Invention

This invention relates to a display control field, and more particularly to a display processing method, a display processing device and a display device.

2. Description of the Prior Art

In a display device, there is a nonlinear relationship between brightness of a pixel and a voltage applied to the pixel. The nonlinear relationship is shown in a curve named Gamma curve.

A signal of a general pixel is a digital signal. Because of the nonlinear relationship between the brightness of a pixel and the voltage applied to the pixel, the display device needs to convert a pixel signal into a corresponding driving voltage according to the Gamma curve and outputs the driving voltage, so that there is a linear relationship between the pixel signal and the brightness of the pixel.

In a conventional display device, voltage conversion is implemented based on a predetermined Gamma curve. However, such voltage conversion does not bring out a good display effect as described herein.

Almost all of the electrical devices are capable of processing a 3D play task and a 2D display task in parallel, for example, displaying a 3D movie play interface and a text edit interface simultaneously.

Since different types of display data having different characteristics respectively, for example, a text edit interface is in very bright and a movie display interface varies in time, when a 3D play task and a 2D display task are processed in parallel, the Gamma curve can only be used for either one of the tasks. Therefore, the other task will have a poor display effect, for example, the 3D play task has a very dark display picture in the case of the bright being adapted to the task of text editing.

### SUMMARY OF THE INVENTION

The embodiments of the present invention aim to provide a display processing method, a display processing device and a display device so that display effect is improved.

In order to achieve the above object, the embodiments of the present invention provide a display processing method, used for a display device having display areas, wherein, the display processing method comprising:
obtaining a first area of the display device which is currently displaying 3D display data; controlling the display in the first area based on a first GAMMA curve, and controlling the display in a second area other than the first area in the display area based on a second GAMMA curve;
wherein the first GAMMA curve is different from the second GAMMA curve.

In the above display processing method, the first GAMMA curve is above the second GAMMA curve in the coordinates of the GAMMA curves.

In the above display processing method,
the brightness of a first picture is larger than that of a second picture that in the first area;
the brightness of the first picture is the brightness of a display picture which corresponds to the 3D display data and is shown in the first area when the display in the first area is controlled based on the first GAMMA curve;
the brightness of the second picture is the brightness of a display picture which corresponds to the 3D display data and is shown in the first area when the display in the first area is controlled based on the second GAMMA curve.

In the above display processing method, controlling the display in the first area based a first GAMMA curve comprises:
analyzing the current frame of the 3D display data, obtaining a gray level distribution of a display picture corresponding to the current frame of the 3D display data;
adjusting the first GAMMA curve according to the gray level distribution to obtain a third GAMMA curve;
controlling the display in the first area based on the third GAMMA curve.

In the above display processing method, the display device comprises a plurality of backlight units, each of the backlight units corresponds to a part of the display area, the display processing method further comprises:
analyzing the current frame of the 3D display data, obtaining a brightness distribution of the pixels corresponding to the current frame of the 3D display data;
adjusting the brightness of a backlight unit corresponding to the first area based on the brightness distribution, so that the brightness of the backlight unit corresponding to the first area matches with the brightness distribution of the pixels.

In order to achieve the above object, the embodiments of the present invention further provide a display processing device, used for a display device having display areas, wherein, the display processing device comprises:
a determining module, configured to obtain a first area of the display device which is currently displaying 3D display data;
a control module, configured to control the display in the first area based on a first GAMMA curve, and to control the display in a second area other than the first area in the display areas based on a second GAMMA curve;
wherein the first GAMMA curve being different from the second GAMMA curve.

In the above display processing device, the first GAMMA curve is above the second GAMMA curve in the coordinates of the GAMMA curves.

In the above display processing device,
the brightness of a first picture is larger than that of a second picture that in the first area;
the brightness of the first picture is the brightness of a display picture which corresponds to the 3D display data and is shown in the first area when the display in the first area is controlled based on the first GAMMA curve;
the brightness of the second picture is the brightness of a display picture which corresponds to the 3D display data and is shown in the first area when the display in the first area is controlled based on the second GAMMA curve.

In the above display processing device, the control module comprises:
a grey level distribution analyzing unit, configured to analyze the current frame of the 3D display data, to obtain a gray level distribution of a display picture corresponding to the current frame of the 3D display data;
an adjusting unit, configured to adjust the first GAMMA curve based on the grey level distribution to obtain a third GAMMA curve;
a first control unit, configured to control the display in the first area based on the third GAMMA curve.

In the above display processing device, the display device comprises a plurality of backlight units, each of the backlight units corresponding to a part of display area, the display processing device further comprises:
a brightness distribution analyzing module, configured to analyze the current frame of the 3D display data, to obtain a brightness distribution of the pixels corresponding to the current frame of the 3D display data;
a backlight adjustment unit, configured to adjust the brightness of a backlight unit corresponding to the first area based on the brightness distribution, so that the brightness of the backlight unit corresponding to the first area matches with the brightness distribution of the pixels.

In order to achieve the above object, the embodiments of the present invention further provide a display device, comprising the above display processing device.

The embodiments of the present invention at least obtained the beneficial effects as follows.

In the embodiments of the present invention, different GAMMA curves are used to control the displays in a 3D display area and a 2D display area individually. As compared with the prior art, the same GAMMA curved is not used for controlling both of the 3D display area and the 2D display area. GAMMA curves adapt to different types of the pixels in the display areas are used to control the display thereof respectively, according to the types of display areas. Therefore, the display effect is improved.

### BRIEF DESCRIPTION OF THE DRAWINGS

FIG. 1 is a schematic flowchart illustrating the display processing method according to an embodiment of the present invention;

FIG. 2 is a detailed flowchart illustrating the display processing method according to an embodiment of the present invention;

FIG. 3 is a schematic diagram illustrating selecting Gamma curves under various scenes while applying the display processing method according to an embodiment of the present invention;

FIG. 4 is a schematic illustrating the structure of the display processing device according to an embodiment of the present invention.

### DETAILED DESCRIPTION OF THE PREFERRED EMBODIMENTS

In a display processing method, a display processing device and a display device according to an embodiment of the present invention, different GAMMA curves are applied to control the display in a 3D display area and in a 2D display area individually. Since GAMMA curves adapt to various display types are used for controlling the display thereof respectively, the display effect is improved.

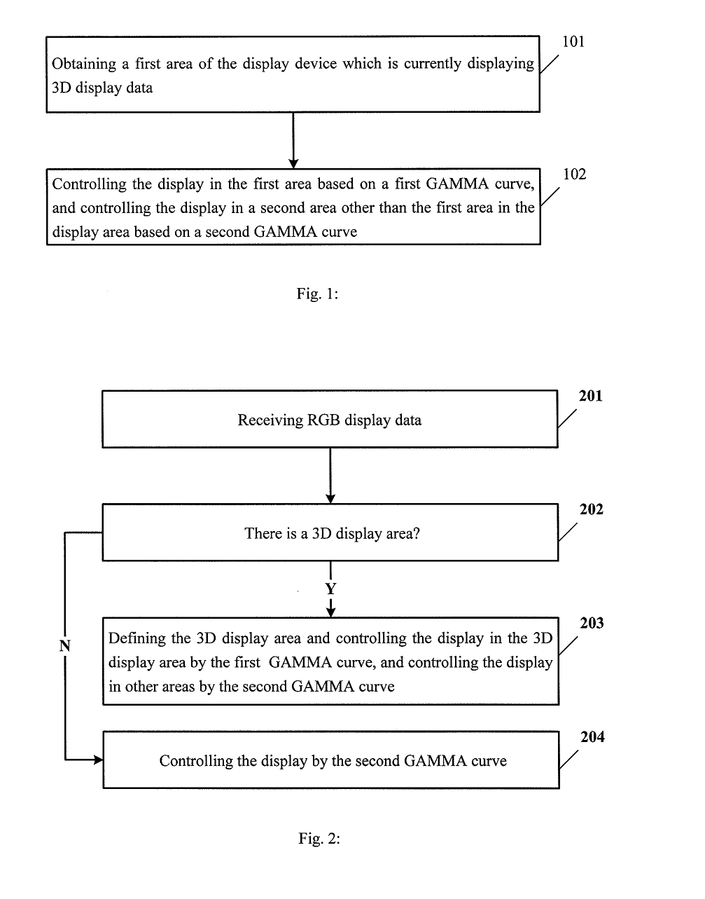

The display processing method according to an embodiment of the present invention is used for a display device having display areas. As shown in FIG. 1, the display processing method includes:

Step 101, obtaining a first area of the display device which is currently displaying 3D display data;

Step 102, controlling the display in the first area based on a first GAMMA curve, and controlling the display in a second area other than the first area in the display area based on a second GAMMA curve;

The first GAMMA curve is different from the second GAMMA curve.

In the display processing method according to an embodiment of the present invention, different GAMMA curves are used to control the displays in a 3D display area and a 2D display area individually. As compared with the prior art, in the present embodiment, the same GAMMA curved is not used for controlling both of the 3D display area and the 2D display area. GAMMA curves adapt to various types of display areas are used to control the display of pixels in the corresponding display areas respectively. Therefore, the display effect is improved.

In an embodiment of the present invention, a first GAMMA curve and a second GAMMA curve are obtained by practical measurements. Obviously, other possible methods can be used to obtain the first GAMMA curve and the second GAMMA curve, which will not be described in details herein.

In an embodiment of the present invention, the first area which is currently displaying the 3D display data can be obtained by various methods, for example, appointed by a user. For doing this, a user directly inputs the position information of the first area by an input device or a user selects the first area in a display screen by a mouse.

Obviously, the first area can be obtained by analysis. Since the data of a 3D movie have specific features, such features can be obtained by analyzing the data sent to a video card. If the data sent to the video card meet with the features of the 3D display data, a display area that displaying the 3D display data can be further determined.

Obviously, the area of the display device used to display the 3D display data can be obtained by other ways according to an embodiment of the present invention, which will not be specified herein.

The application of an embodiment of the present invention is described in details as follows.

Firstly, in the embodiment of the present invention, two GAMMA curves are pre-stored, one is used for 3D display and the other is used for 2D display.

Conventionally, one GAMMA curve is pre-stored in a display device before shipping. According to an embodiment of the present invention, another GAMMA curve used for 3D display is added. The added GAMMA curve used for 3D display can be obtained by the same way as that for a GAMMA curve in the prior art, which will not be specified herein.

The embodiments of the present invention can be applied for the following various scenes: only 2D display data will be displayed, only 3D display data will be displayed, and both 2D display data and 3D display data will be displayed in a mixed way, which will be specified as follows.

Scene 1

In scene 1, only 2D display data are displayed. Under this circumstance, since only 2D display data are displayed, a first area which displays 3D display data does not exist. When it is determined that the whole area is a 2D display area, the second GAMMA curve that is used for the 2D display area is directly used for display control.

Scene 2

In scene 2, only 3D display data are displayed. Under this circumstance, since only 3D display data are displayed, a second area which displays 2D display data does not exist. When it is determined that the whole area is a 3D display area, the first GAMMA curve that is used for the 3D display area is directly used for display control.

Scene 3

In scene 3, both 2D display data and 3D display date are displayed simultaneously.

Under this circumstance, since both 2D display data and 3D display date are displayed simultaneously, both the first area and the second area exist at the same time.

The processing procedure under this circumstance is shown in FIG. 2, comprising:

Step 201, receiving RGB display data;

Step 202, determining whether a 3D display area exists, if a 3D display area exists, proceed to step 203, otherwise, proceed to step 204;

Step 203, defining the 3D display area and controlling the display in the 3D display area by the first GAMMA curve, and controlling the display in other areas by the second GAMMA curve;

Step 204, controlling the display by the second GAMMA curve.

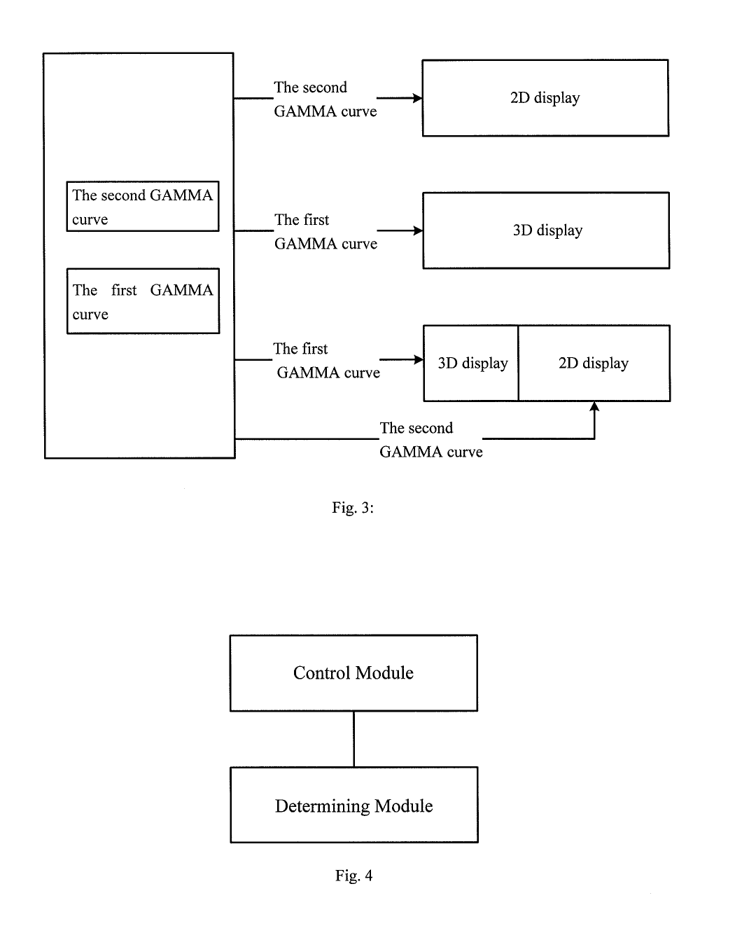

The GAMMA curves used in the above three scenes are shown in FIG. 3, that is,

When only 2D display data are displayed, the second GAMMA curve is directly used to control the display in the entire display area;

When only 3D display data are displayed, the first GAMMA curve is directly used to control the display in the entire display area;

When both 2D display data and 3D display data are displayed simultaneously, the first GAMMA curve is used to control the display in the 3D display area and the second GAMMA curve is used to control the display in the 2D display area.

In the embodiment of the present invention, while a display device implementing a 3D display task and a 2D display task in parallel, the display pictures corresponding to the 3D display data are commonly darker as compared with a usual condition. Therefore, if the picture of the 3D display data per ser is relatively dark, the display pictures of the 3D display data will be even darker, results in the pictures cannot be clearly viewed by a user. Meanwhile, due to the 2D display area is relatively bright, the brightness difference between the 3D display area and the 2D display area is very large, which will exacerbate the user's visual fatigue.

Based on the above circumstances, in the embodiments of the present invention, the first GAMMA curve is above the second GAMMA curve in the coordinates of the GAMMA curves.

That is, as compared with applying the second GAMMA curve, applying the first GAMMA curve will increase the brightness of the pictures in the 3D display area.

That is, in the embodiment of the present invention, the brightness of the first picture is larger than that of the second picture in the first area.

The brightness of the first picture is the brightness of a display picture which corresponding to the 3D display data and is shown in the first area, in the case that the display in the first area is controlled based on the first GAMMA curve.

The brightness of the second picture is the brightness of a display picture which corresponding to the 3D display data and is shown in the first area, in the case that the display in the first area is controlled based on the second GAMMA curve.

The pictures in the 3D display area are relatively dark as a whole under some conditions or relatively bright under some other conditions. Therefore, if a unified GAMMA curve is used, it will make the relatively dark picture becomes darker or the relatively bright picture becomes brighter, the picture quality is poor and the pictures cannot be clearly discriminated by a user.

With respect to the above condition, in the embodiment of the present invention, the 3D display area is adjusted based on the initial first GAMMA curve, so as to obtain a third GAMMA curve, which is used to further improve the picture quality, and the display in the first area is controlled based on the third GAMMA curve.

In this way, controlling the display in the first area based on the first GAMMA curve comprises:

Analyzing the current frame of the 3D display data, obtaining the gray level distribution of a display picture corresponding to the current frame of the 3D display data;

Adjusting the first GAMMA curve according to the gray level distribution and obtaining a third GAMMA curve;

Controlling the display in the first area based on the third GAMMA curve.

The above way is exemplified as follows.

Firstly, the gray level distributions of all pixels corresponding to the current frame are counted, that is, the number of pixels in grey level 0, the number of pixels in grey level 1, . . . , the number of pixels in grey level 255 are counted.

The type of the current frame is determined to be a frame containing more white pixels or a frame containing more black pixels based on the statistic result.

The above determination can be made based on the percentage of the number of pixels whose gray level is larger than a preset threshold (such as 128). If the percentage of the number of pixels whose gray level is larger than a preset threshold (such as 128) exceeds 70% (which is only an example, the percentage may be other values, such as 85%, 65% and so on), the current frame is determined as a frame containing more black pixels. If the percentage of the number of pixels whose gray level is less than a preset threshold (such as 128) exceeds 70% (which is only an example, the percentage may be other values, such as 85%, 65% and so on), the current frame is determined as a frame containing more white pixels.

After the type is determined, the first GAMMA curve can be adjusted to obtain the third GAMMA curve.

In general, if the current frame is a frame containing more white pixels, the pixels of the white portions need to be subdivided, that is, in the coordinates of the GAMMA curves, the third GAMMA curve is below the first GAMMA curve. If the current fame is a frame containing more black pixels, the pixels of the black portions need to be subdivided, that is, in the coordinates of the GAMMA curves, the third GAMMA curve is above the first GAMMA curve.

Obviously, in order to improve the issue that 3D display picture is relatively dark while the 3D display and the 2D display are implemented in parallel, the backlight brightness can be simultaneously adjusted.

In this way, the display device includes a plurality of backlight units, each of the backlight unit corresponding to a part of display area, the display processing method further comprises:

Analyzing the current frame of the 3D display data, obtaining the brightness distribution of the pixels corresponding to the current frame of the 3D display data;

Adjusting the brightness of a backlight unit corresponding to the first area based on the brightness distribution, so that the brightness of the backlight unit corresponding to the first area matches with the brightness distribution of the pixels.

The embodiment of the present invention further provides a display processing device used for a display device having display areas. As shown in FIG. 4, the display processing device comprises:

A determining module, configured to obtain a first area of the display device which is currently displaying 3D display data;

A control module, configured to control the display in the first area based on a first GAMMA curve, and to control the display in a second area other than the first area in the display areas based on a second GAMMA curve;

The first GAMMA curve is different from the second GAMMA curve.

In the embodiment of the present invention, in order to guarantee the brightness of the pictures in the 3D display area and decrease the brightness difference between the 3D display area and the 2D display area, the first GAMMA curve is above the second GAMMA curve in the coordinates of the GAMMA curves.

In this way, the brightness of the first picture is larger than the brightness of the second picture in the first area;

The brightness of the first picture is the brightness of the display pictures which corresponding to the 3D display data and are shown in the first area in the case that the display in the first area is controlled based on the first GAMMA curve.

The brightness of the second picture is the brightness of the display pictures which corresponding to the 3D display data and are shown in the first area in the case that the display in the first area is controlled based on the second GAMMA curve.

In the embodiment of the present invention, in order to further improve display quality, the control module further comprises:

A grey level distribution analyzing unit, configured to analyze the current frame of the 3D display data , and obtain the gray level distribution of a display picture corresponding to the current frame of the 3D display data;

An adjusting unit, configured to adjust the first GAMMA curve based on the grey level distribution and obtain a third GAMMA curve;

A first control unit, configured to control the display in the first area based on the third GAMMA curve.

Meanwhile, in the embodiment of the present invention, the adjustment can be implemented in associated with the backlight brightness. In this way, the display device includes a plurality of backlight units, each of the backlight units corresponding to a part of display area, the display processing device further comprises:

A brightness distribution analyzing module, configured to analyze the current frame of the 3D display data, and obtain the brightness distribution of pixels corresponding to the current frame of the 3D display data;

A backlight adjustment unit, configured to adjust the brightness of a backlight unit corresponding to the first area based on the brightness distribution, so that the brightness of the backlight unit corresponding to the first area matches with the brightness distribution of the pixels.

The embodiment of the present invention further provides a display device comprising the above display processing device.

The above mentioned are only the embodiments of the present disclosure, which is not intended to limit the protection scope of he present disclosure. It should be noted that, to those skilled in the art, any change, alternative, and modification within the spirit and principle of the embodiment of the present disclosure should belong to the scope of protected by the present disclosure.

What is claimed is:

1. A display processing method, used for a display device having display areas, the display processing method comprising:
obtaining a first area of the display device which is currently displaying 3D display data;
controlling the display in the first area based on a first GAMMA curve, and controlling the display in a second area other than the first area in the display area based on a second GAMMA curve;
wherein the first GAMMA curve is different from the second GAMMA curve.

2. The display processing method according to claim 1, wherein,
in the coordinates of the GAMMA curves, the first GAMMA curve is above the second GAMMA curve.

3. The display processing method according to claim 2, wherein,
the brightness of a first picture is larger than that of a second picture in the first area;
the brightness of the first picture is the brightness of a display picture which corresponds to the 3D display data and is shown in the first area when the display in the first area is controlled based on the first GAMMA curve;
the brightness of the second picture is the brightness of a display picture which corresponds to the 3D display data and is shown in the first area when the display in the first area is controlled based on the second GAMMA curve.

4. The display processing method according to claim 1, wherein the step of controlling the display in the first area based on a first GAMMA curve comprises:
analyzing the current frame of the 3D display data, obtaining a gray level distribution of a display picture corresponding to the current frame of the 3D display data;
adjusting the first GAMMA curve according to the gray level distribution and obtaining a third GAMMA curve;
controlling the display in the first area based on the third GAMMA curve.

5. The display processing method according to claim 4, wherein the step of analyzing the current frame of the 3D display data, obtaining a gray level distribution of a display picture corresponding to the current frame of the 3D display data comprises:
counting the gray level distributions of all pixels corresponding to the current frame of 3D display data;
in which, determining the type of the current frame to be a frame containing more black pixels if the percentage of the number of pixels whose gray level is larger than a preset threshold exceeds a predetermined value, and to be a frame containing more white pixels if the percentage of the number of pixels whose gray level is less than a preset threshold exceeds the predetermined value.

6. The display processing method according to claim 5, wherein the step of adjusting the first GAMMA curve according to the gray level distribution and obtaining a third GAMMA curve comprises:
the third GAMMA curve being above the first GAMMA cure in the coordinates of the GAMMA curves, when the current frame being a frame containing more black pixels; and the third GAMMA curve being below the first GAMMA curve in the coordinates of the GAMMA curves, when the current frame being a frame containing more white pixels.

7. The display processing method according to claim 1, wherein the display device comprises a plurality of backlight units, each of the backlight units corresponding to a part of display area, the display processing method further comprises:
analyzing the current frame of the 3D display data, obtaining a brightness distribution of pixels corresponding to the current frame of the 3D display data;
adjusting the brightness of a backlight unit corresponding to the first area based on the brightness distribution, so that the brightness of the backlight unit corresponding to the first area matches with the brightness distribution of the pixels.

8. A display processing device, used for a display device having display areas, the display processing device comprising:
a determining module, configured to obtain a first area of the display device which is currently displaying 3D display data;
a control module, configured to control the display in the first area based on a first GAMMA curve, and to control the display in a second area other than the first area in the display areas based on a second GAMMA curve;
wherein the first GAMMA curve being different from the second GAMMA curve.

9. The display processing device according to claim 8, wherein,
in the coordinates of the GAMMA curves, the first GAMMA curve is above the second GAMMA curve.

10. The display processing device according to claim 9, wherein,
the brightness of a first picture is larger than that of a second picture in the first area;
the brightness of the first picture is the brightness of a display picture which corresponds to the 3D display data and is shown in the first area when the display in the first area is controlled based on the first GAMMA curve;
the brightness of the second picture is the brightness of a display picture which corresponds to the 3D display data and is shown in the first area when the display in the first area is controlled based on the second GAMMA curve.

11. The display processing device according to claim 8, wherein the control module comprises:
a grey level distribution analyzing unit, configured to analyze the current frame of the 3D display data, and obtain a gray level distribution of a display picture corresponding to the current frame of the 3D display data;
an adjusting unit, configured to adjust the first GAMMA curve based on the grey level distribution and obtain a third GAMMA curve;
a first control unit, configured to control the display in the first area based on the third GAMMA curve.

12. The display processing device according to claim 11, wherein,
the grey level distribution analyzing unit is further configured to count the gray level distribution of all pixels corresponding to the current frame of 3D display data, and determine the type of the current frame based on the results of the counting;
wherein, the type of the current frame is determined to be a frame containing more black pixels if the percentage of the number of pixels whose gray level is larger than a preset threshold exceeds a predetermined value, and to be a frame containing more white pixels if the percentage of the number of pixels whose gray level is less than a preset threshold exceeds the predetermined value.;

13. The display processing device according to claim 12, wherein,
the adjusting unit is further configured to adjust the first GAMMA curve in the coordinates of the GAMMA curves, so that the third GAMMA curve being above the first GAMMA cure in the case that the current frame being a frame containing more black pixels; and
to adjust the first GAMMA curve in the coordinates of the GAMMA curves, so that the third GAMMA curve being below the first GAMMA curve in the case that the current frame being a frame containing more white pixels.

14. The display processing device according to claim 8, wherein the display device comprises a plurality of backlight units, each of the backlight units corresponding to a part of display area, the display processing device further comprises:
a brightness distribution analyzing module, configured to analyze the current frame of the 3D display data, and obtain the brightness distribution of pixels corresponding to the current frame of the 3D display data;
a backlight adjustment unit, configured to adjust the brightness of a backlight unit corresponding to the first area based on the brightness distribution, so that the brightness of the backlight unit corresponding to the first area matches with the brightness distribution of the pixels.

15. A display device, comprising the display processing device according to claim 8.

16. The display device according to claim 15, wherein, in the coordinates of the GAMMA curves, the first GAMMA curve is above the second GAMMA curve.

17. The display device according to claim 16, wherein,
the brightness of a first picture is larger than that of a second picture in the first area;
the brightness of the first picture is the brightness of a display picture which corresponds to the 3D display data and is shown in the first area when the display in the first area is controlled based on the first GAMMA curve;
the brightness of the second picture is the brightness of a display picture which corresponds to the 3D display data and is shown in the first area when the display in the first area is controlled based on the second GAMMA curve.

18. The display device according to claim 15, wherein,
the control module comprises:
a grey level distribution analyzing unit, configured to analyze the current frame of the 3D display data, and obtain a gray level distribution of a display picture corresponding to the current frame of the 3D display data;
an adjusting unit, configured to adjust the first GAMMA curve based on the grey level distribution and obtain a third GAMMA curve;
a first control unit, configured to control the display in the first area based on the third GAMMA curve.

19. The display device according to claim 15, wherein,
the display device comprises a plurality of backlight units, each of the backlight units corresponding to a part of display area, the display processing device further comprises:
a brightness distribution analyzing module, configured to analyze the current frame of the 3D display data, and obtain the brightness distribution of pixels corresponding to the current frame of the 3D display data;
a backlight adjustment unit, configured to adjust the brightness of a backlight unit corresponding to the first area based on the brightness distribution, so that the brightness of the backlight unit corresponding to the first area matches with the brightness distribution of the pixels.
